(19) United States
(12) Patent Application Publication
(10) Pub. No.: US 2025/0202645 A1
(43) Pub. Date: Jun. 19, 2025

(54) BLE TELECOMMUNICATION METHOD IMPLEMENTED BETWEEN A FIRST TELECOMMUNICATION DEVICE AND A SECOND TELECOMMUNICATION DEVICE

(71) Applicant: COMMISSARIAT A L’ENERGIE ATOMIQUE ET AUX ENERGIES ALTERNATIVES, PARIS (FR)

(72) Inventors: Tristan CAROFF, GRENOBLE (FR); Maxime GALLARDO, GRENOBLE (FR); Jean-Philippe GROS, GRENOBLE (FR)

(21) Appl. No.: 18/980,766

(22) Filed: Dec. 13, 2024

(30) Foreign Application Priority Data
Dec. 13, 2023 (FR) 2314093

(51) Int. Cl. H04L 5/00; H04W 4/80; H04W 72/0453

(52) U.S. Cl. CPC H04L 5/0048; H04W 72/0453; H04W 4/80

(57) ABSTRACT

A BLE telecommunication method, BLE standing for Bluetooth Low Energy, is implemented by a first telecommunication device, frames TR_i, i=n−N to n, including a first field for current data and N second fields for data transmitted in the first field of previously transmitted frames; including, during construction of frame TR_n, inserting: into the first data field of frame TR_n, the dataset D_n; into the jth second data field of frame TR_n, j=1 to N, the dataset D_(n−j) previously transmitted in the first field of frame TR_(n−j); the channel selected for transmission of frame TR_n−j being the channel succeeding, in the defined loop, the channel that was selected for transmission of frame TR_(n−j−1) at transmission time t_(n−j−1), j=0 to N.

### CROSS-REFERENCE TO RELATED APPLICATION

This application claims priority to foreign French patent application No. FR 2314093, filed on Dec. 13, 2023, the disclosure of which is incorporated by reference in its entirety.

### FIELD OF THE INVENTION

The invention relates to the field of BLE telecommunications (BLE standing for Bluetooth Low Energy), which are in particular implemented in IoT-related applications (IoT standing for Internet of Things).

### BACKGROUND

There are generally four main alternative roles played by a device configured to implement BLE telecommunications:
central: refers to a device that discovers peripherals and BLE broadcasters with the ability to connect to peripherals;
peripheral: refers to a device that makes its existence known with the ability to accept connections from a central device;
broadcaster: refers to a device that sends advertising packets without authorising any connections;
observer: refers to a device that discovers peripheral and broadcaster devices, but without the ability to accept connections from a central device.

A peripheral or broadcaster device always starts with an advertising mode before accepting a connection. In fact, advertising packets are the only means allowing a central or observer device to discover a peripheral or broadcaster device. The difference between two BLE devices in connected mode and advertising/discovery mode is that connected mode allows two-way data transfer between the two connected devices. In contrast, a device in advertising mode (peripheral or broadcaster) cannot receive any data from an observer/central device in this state.

In advertising mode, a device sends packets containing payload data. These packets are generally sent at a fixed interval, called the advertising interval.

There are 40 radio-frequency (RF) channels in BLE, spaced apart from each other centre-to-centre by 2 MHz. Three of these channels, numbered 37, 38 and 39, are primary advertising channels. The other 37 channels are secondary advertising channels and are also used for data transfer during a connection. The secondary channels are used as “auxiliary” channels, this meaning that a device must first transmit advertising packets on the primary advertising channels before sending advertising packets on the secondary channels. If a device wishes to use secondary advertising channels, it sends advertising packets on the primary channels indicating the secondary channels to use.

The conventional manner of operation of a BLE communication in advertising mode (broadcast/not connected) between a first BLE device and a second device, a smartphone for example, is illustrated with reference to FIG. 5 and FIG. 6.

In order to limit interference with other connected objects and Wi-Fi bands, things communicating via BLE in advertising mode transmit their data on channels 37, 38 and 39 (dedicated to BLE) consecutively. The average power required to transmit a 47-byte frame is about 33 to 45 μJ.

Thus, with reference to the bottom part of FIG. 6, the same data are transmitted by the first device, labelled A, successively on channel 37, then 38, then 39, corresponding to transmissions E1₃₇, E1₃₈ and E1₃₉. Next, the following payload data are transmitted, after an advertising interval, for example of duration equal to 20 ms (milliseconds) successively on channel 37, then 38, then 39: E2₃₇, E2₃₈, E2₃₉.

Conventionally, with reference to the bottom part of FIG. 6, the BLE receiver (observer/scanner), labelled S, initiates, about every 50 ms to 200 ms (scan interval), a phase of scanning one channel at a time. The scan time is generally of the order of 25 ms to 100 ms (scan window). It subsequently stops scanning for an interval of the same order of magnitude, before starting to scan the following advertising channel. The scanned channel is thus rotated through channels 37, 38 and 39.

It is not recommended/recommendable to transmit on a single set BLE channel as this decreases immunity to interference and increases the risk of collisions between data.

The channel uses a frequency band that may also be used by other devices using BLE but also conventional Bluetooth, Wi-Fi, ZigBee and Thread (see FIG. 7 taken from: S. Silva, S. Soares, T. Fernandes, A. Valente and A. Moreira, “Coexistence and interference tests on a Bluetooth Low Energy front-end,” 2014 Science and Information Conference, London, UK, 2014, pp. 1014-1018, doi: 10.1109/SAI.2014.6918312), which further increases the risk of interference between various channels. For this reason, it is recommended to broadcast on all 3 channels dedicated to BLE advertising mode as described above.

Some publications mention transmission/reception on 1 single (BLE) channel, in order to minimize the power consumed when sending data. In this type of setup, as illustrated in FIG. 8, a dedicated Bluetooth frame scanner/sniffer S (allowing 1 channel, channel 38 for example, to be constantly scanned) is generally used, the first device A also transmitting only on the one channel in question.

It is also conceivable, as illustrated in FIG. 9, to use this type of transmission with a smartphone as BLE receiver (labelled Se), the channel being rotated reception end with a dead time between each channel change, but this greatly limits the number of frames received.

There is a need to minimize the power required to communicate in BLE, in particular in BLE advertising mode, for example with a smartphone single-channel receiver, while guaranteeing the reliability of the communication (limitation of problems due to interference) and reconstruction of the data (minimization of data loss).

### SUMMARY OF THE INVENTION

To this end, according to a first aspect, the present invention describes a BLE telecommunication method implemented between a first telecommunication device and a second telecommunication device,

frames TR_i having previously been transmitted to the second telecommunication device by the first telecommunication device at respective successive transmission times t_i, i=n−N to n−1, N, i and n being integers and N≥3;
P telecommunication channels having been allocated for BLE telecommunications between said first and second devices;
said method comprising the following steps implemented by the first telecommunication device with a view to transmitting, at transmission time t_n, a new dataset D_n to be transmitted:
obtaining the new dataset D_n to be transmitted;
constructing a frame, called frame TR_n, in light at least of the obtained dataset D_n;
selecting one telecommunication channel among said P allocated telecommunication channels;
transmitting, on the selected channel, the constructed frame T_n;
said method being characterized in that the following steps are implemented by the first telecommunication device to transmit, at transmission time t_n, frame TR_n, each of the frames TR_i, i=n−N to n, conforming to a predefined frame format comprising a first data field intended to contain the current data and comprising N second data fields intended to contain data transmitted in the first field of previously transmitted frames;
during construction of frame TR_n:
inserting, into the first data field of frame TR_n, the dataset D_n;
inserting, into the jth second data field of frame TR_n, j=1 to N, the dataset D_(n−j) previously transmitted in the first field of frame TR_(n−j);
during selection of the communication channel:
a loop having been defined on the P channels ordered in a defined order, the channel selected for transmission of frame TR_n is the channel succeeding, in said defined loop, the channel that was selected for transmission of frame TR_(n−1) at transmission time t_(n−1); the channel previously selected for transmission of frame TR_n−j being the one succeeding, in said defined loop, the channel that was selected for transmission of frame TR_(n−j−1) at transmission time t_(n−j−1), j=1 to N;
said frame TR_n further being transmitted only on the single selected channel and in particular not being re-transmitted on any other of the P channels.

The invention allows the power required to communicate in BLE to be minimized, this being particularly advantageous in IoT applications requiring low-power wireless communication or in systems with energy harvesting.

In some embodiments, such a method will furthermore comprise at least one of the following features:
the spacing between two successive transmission times remains constant;
dataset D_i indicates the transmission time t_i, i=n−N to n, of frame TR_i;
a scan window T_{SW} having been predefined and a scan interval T_{Si} having been defined, the second telecommunication device implements, every scan interval T_{Si}, a step of scanning, during the predefined scan window T_{SW}, one considered channel among the P channels, said P channels each being considered one after another, before starting again from the beginning.

According to another aspect, the invention describes a computer program intended to be stored in the memory of a first telecommunication device further comprising a microcomputer, said computer program comprising instructions that, when they are executed on the microcomputer, implement the steps of a method according to the first aspect of the invention.

The invention also describes a non-transient computer-readable medium storing such a computer program.

According to another aspect, the invention describes a telecommunication device, called the first telecommunication device below, configured to implement a BLE telecommunication with a second telecommunication device,

frames TR_i having previously been transmitted to the second telecommunication device by the telecommunication device at respective successive transmission times t_i, i=n−N to n−1, N, i and n being integers and N≥3;
P telecommunication channels having been allocated for BLE telecommunications between said first and second devices;
the first telecommunication device being configured, with a view to transmitting, at transmission time t_n, a new dataset D_n to be transmitted, to obtain the new dataset D_n to be transmitted, to construct a frame, called frame TR_n, in light at least of the obtained dataset D_n, to select one telecommunication channel among said P allocated telecommunication channels, and to transmit, on the selected channel, the constructed frame T_n;
said first telecommunication device being characterized in that the first telecommunication device, with a view to transmitting, at transmission time t_n, frame TR_n, each of the frames TR_i, i=n−N to n, conforming to a predefined frame format comprising a first data field intended to contain the current data and comprising N second data fields intended to contain data transmitted in the first field of previously transmitted frames, during construction of frame TR_n, inserts, into the first data field of frame TR_n, the dataset D_n, and inserts, into the jth second data field of frame TR_n, j=1 to N, the dataset D_(n−j) previously transmitted in the first field of frame TR_(n−j);
said first telecommunication device being configured to, a loop having been defined on the P channels ordered in a defined order, select as communication channel for transmission of frame TR_n, the channel succeeding, in said defined loop, the channel that was selected for transmission of frame TR_(n−1) at transmission time t_(n−1); the channel previously selected for transmission of frame TR_n−j being the one succeeding, in said defined loop, the channel that was selected for transmission of frame TR_(n−j−1) at transmission time t_(n−j−1), j=1 to N;
said frame TR_n further being transmitted only on the single selected channel and in particular not being re-transmitted on any other of the P channels.

In some embodiments, said telecommunication device further comprises one or both of the following features:
it is configured to place a constant spacing between two successive transmission times;
it is configured to indicate, in dataset D_i, the transmission time t_i, i=n−N to n, of frame TR_i.

According to another aspect, the invention relates to a BLE telecommunication system comprising a first telecommunication device (10) according to the invention, wherein a scan window T_{SW} having been predefined and a scan interval T_{Si} having been defined, said system further comprises the second telecommunication device, which is configured to scan, every scan interval T_{Si}, during the predefined scan window T_{SW}, one considered channel among the P channels, said P channels each being considered one after another, before starting again from the beginning.

### BRIEF DESCRIPTION OF THE DRAWINGS

The invention will be better understood and other features, details and advantages will become more clearly apparent on reading the non-limiting description that follows, and by virtue of the appended figures, which are given by way of example.

FIG. 1 is an illustration of a BLE telecommunication system in one embodiment of the invention;

FIG. 2 is a flowchart of steps of a BLE telecommunication method in one embodiment of the invention;

FIG. 3 illustrates the data received and reconstructed in one embodiment of the invention;

FIG. 4 is one example of the composition of the frame transmitted in one embodiment of the invention;

FIG. 5 shows the data channels implemented in BLE communications;

FIG. 6 illustrates prior-art operation of BLE communication;

FIG. 7 shows Wi-Fi, ZigBee, Bluetooth, and BLE spectra;

FIG. 8 illustrates prior-art operation of BLE communication;

FIG. 9 illustrates prior-art operation of BLE communication;

FIG. 10 illustrates operation of BLE communication in one embodiment of the invention;

FIG. 11 is a schematic representation of an application of the invention in one embodiment.

Identical references may be used in various figures to designate identical or comparable elements.

### DETAILED DESCRIPTION

FIG. 1 shows one embodiment of a BLE telecommunication system. It comprises two BLE communication devices configured to implement a method of BLE telecommunication between them in one embodiment of the invention: a first telecommunication device 10 (EM 10) and a second telecommunication device 20 (REC 20). The first device 10 comprises a BLE transmission module 11, including a BLE transmission antenna.

The first device 10 is for example stand-alone in terms of power and is installed on a ski. It is configured to transmit first data relating to the duration and intensity of use of the ski (summed over time) and the classification of the skier's level (evaluation of the degree of deformation of the ski). It for example comprises one or more processing units (not shown), for example a (force) sensor and/or a clock. Payload data obtained from the output of the processing unit (or from the output of the one or more processing units) are transmitted as input to the BLE transmission module 11, which is configured to transmit them in Bluetooth Low Energy (BLE) (advertising mode) in real time to the device REC 20, which is a smartphone for example.

The second device REC 20 comprises a Bluetooth reception module 21, including a Bluetooth reception antenna. This reception module is for example of BLE type, and is called the BLE module 21 below; it is configured to receive data obtained through transmission by the first device 10. The device REC 20 is configured to process these received data and obtain, in light of these data once processed, evaluations of the duration and intensity of use of the ski (summed over time) and the classification of the skier's level.

The BLE transmission module 11 is configured to implement the steps assigned to it of the BLE telecommunication method according to the invention described below in one embodiment of the invention.

The BLE reception module 21 is configured to implement the steps assigned to it of the BLE telecommunication method according to the invention described below in one embodiment of the invention.

P telecommunications channels will have been previously allocated to BLE telecommunications in advertising mode, with P an integer greater than or equal to 2. For example, P is set equal to 3 and the channels are channels 37, 38 and 39.

A loop will have been predefined between the P channels ordered in a set order. For example, here, the loop is channel 37, then channel 38, then channel 39, return to the beginning of the loop, i.e. return to channel 37, then channel 38, then channel 39, etc.

In variants, the set order is 37-38-39 or 37-39-38. It may further comprise one or more repetitions (for example 37-37-38-39) or indeed one or more shifts.

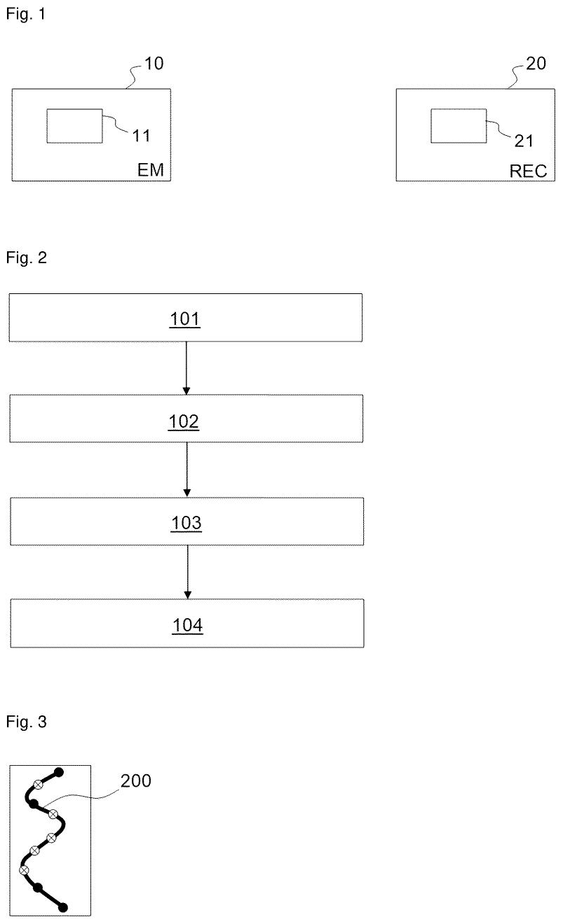

A BLE telecommunication method in one embodiment of the invention will now be described with reference to FIG. 2. The steps of this method are iterated as soon as a new dataset is to be transmitted.

In a step 101, the BLE transmission module 11 obtains the new dataset to be transmitted. It is considered here to be the n^{th} dataset to be transmitted, which dataset is denoted D_n and corresponds to the n^{th} iteration of the method.

Each of the frames TR_i will have been prepared beforehand by the transmission module 11, after the latter has obtained the i^{th} dataset to be transmitted, and will then be transmitted to the device REC 20 at a respective transmission time t_i, in an i^{th} iteration of the method illustrated in FIG. 2. The transmission times t_i follow one after another in time. Here, i=n−N to n−1, where N, i and n are integers and N≥3.

In one embodiment, the largest possible value is taken for N, within the limit of the frame size set by the BLE protocol.

In a step 102, the BLE transmission module 11 constructs frame TR_n, in particular in light of the n^{th} obtained dataset, D_n.

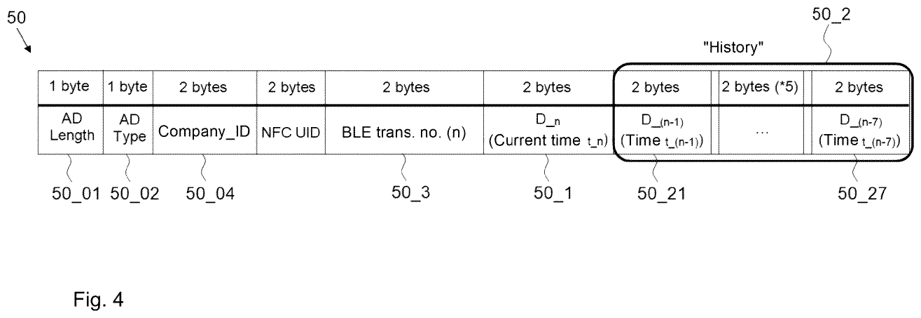

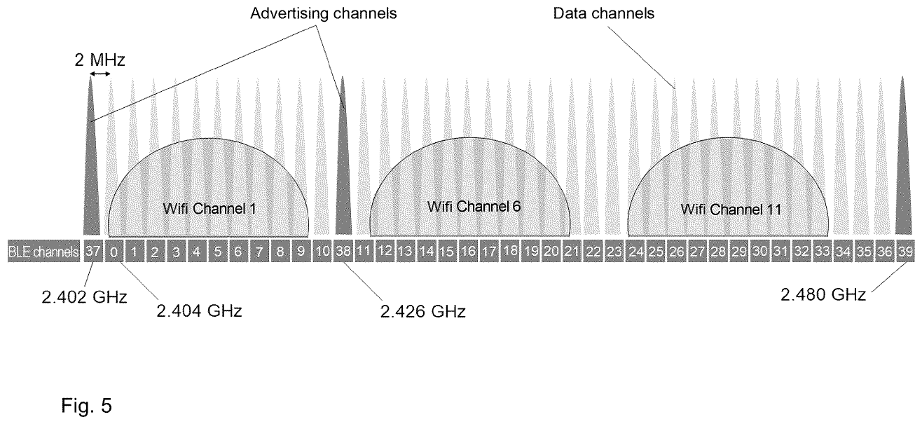

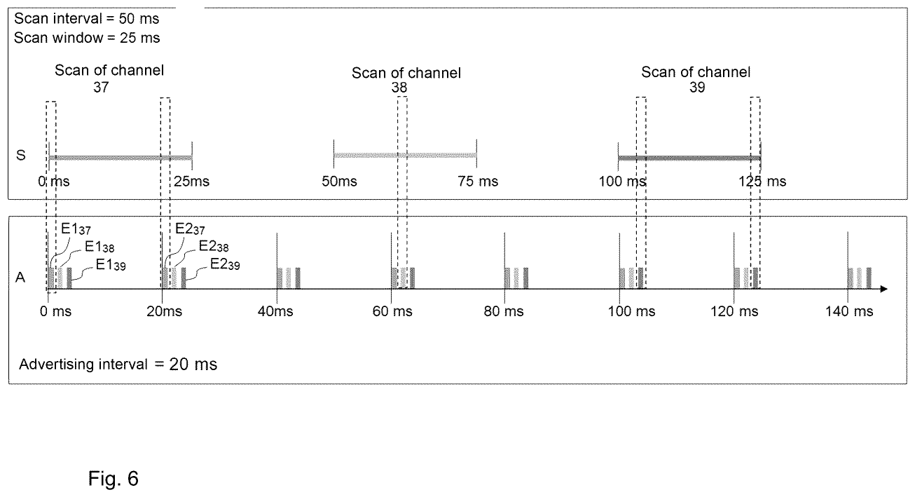

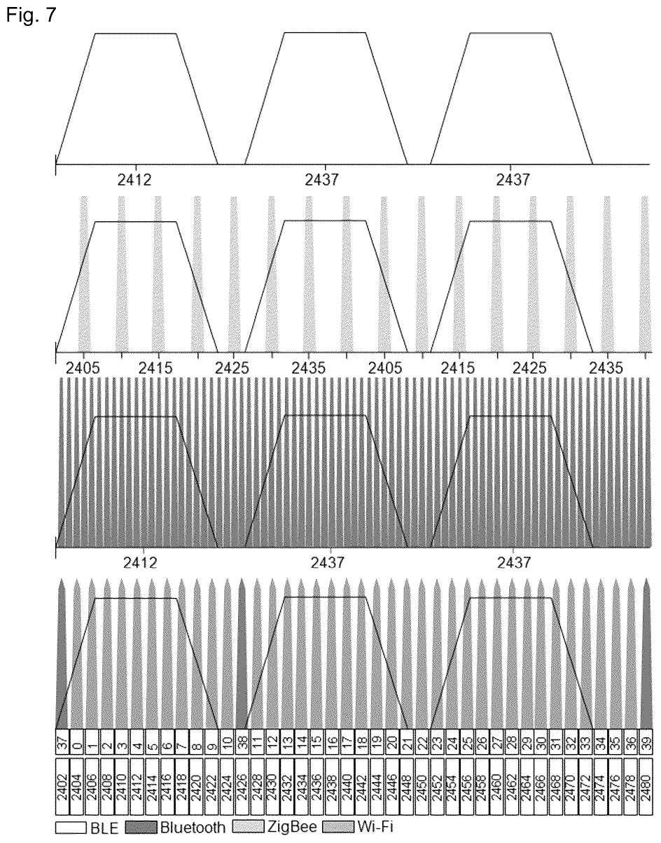

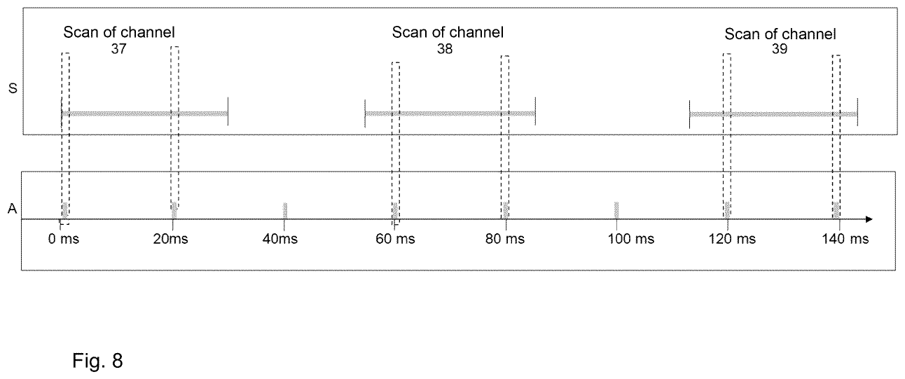

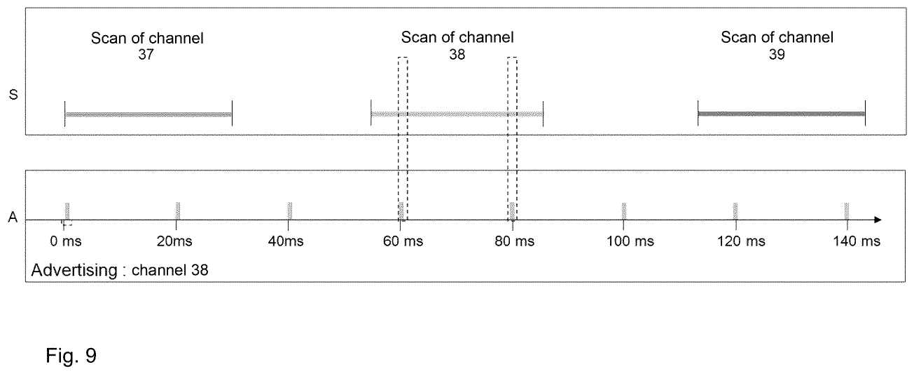

Each of the frames constructed and then transmitted conforms to a predefined frame format 50 (shown in FIG. 4 in one embodiment of the invention) comprising a first data field 50_1 intended to contain the dataset obtained in step 101 of the current iteration and comprising a set 50_2 of N second data fields intended to contain the datasets obtained in step 101 of the N preceding iterations.

In the example shown in FIG. 4, N=7 and the 7 second data fields are referenced 50_1, 50_2, 50_7, respectively; each of the first and second data fields are here 2 bytes in size. The obtained dataset D_n is for example the time stamp of transmission of frame TR_n, i.e. the transmission time t_n of iteration n of the method (the time stamp is, in the present case, set equal to the time at which the frame is created, the time between creation and transmission of the frame being short enough to be neglected in relation to the unit of time employed). Similarly, the obtained dataset D_i is the time stamp of the beginning of implementation of step 101 in iteration i of the method, i=1 to n. In other embodiments, the dataset D_n is (or further comprises) a temperature delivered by a sensor, a level of deformation, etc.

Thus, when constructing frame TR_n, the BLE transmission module 11 inserts:
selectively, into the first data field 50_1 of frame TR_n: the dataset D_n obtained in step 101 of iteration n;
selectively, into the j^{th} second data field 50_2j of frame TR_n, j=1 to N, the dataset D_(n−j) previously transmitted (i.e. transmitted in iteration n−j of the method) in the first field 50_1 of frame TR_(n−j).

In a step 103, the BLE transmission module 11 selects from the P channels dedicated to BLE transmission, the channel on which frame TR_n will be selectively transmitted, by applying this rule:
the channel selected for transmission of frame TR_n is the channel immediately succeeding, in said predefined channel loop, the channel that was selected for transmission of frame TR_(n−1) at transmission time t_(n−1), in iteration (n−1) of the method, the channel previously selected for transmission of frame TR_n−j being the one succeeding, in said defined loop, the channel that was selected for transmission of frame TR_(n−j−1) at transmission time t_(n−j−1).

In a step 104, the BLE transmission module 11 transmits, at transmission time t_n, frame TR_n on the channel thus selected.

Frame TR_n is thus transmitted on only one of the P dedicated channels. Frame TR_n+1, which will be transmitted just after TR_n, will be transmitted only on the channel then selected in iteration n+1. The dataset D_n will, for its part, be inserted into a field of the history 50_2 of TR_n+1.

In the present case, frame TR_n further comprises:
in a field 50_01, the length of the frame, and in a field 50_02 its type, each of these two fields being 1 byte in size,
in a field 50_03, the company identifier, which is 2 bytes in size,
in a field 50_04, an identifier of the device EM 10 (for example, in the case in question, the NFC UID of the device, the field 50_0 here being 8 bytes in size) and, in a field 50_3, which for example is 2 bytes is size, comprises the iteration value n.

The size occupied by the data indicated in FIG. 4 in the case in question is 30 bytes (out for example of the 31 available).

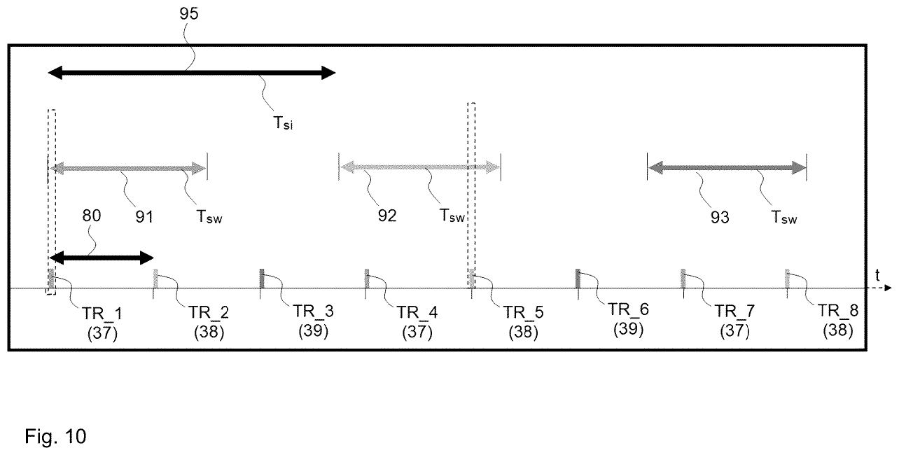

The bottom section of FIG. 10 illustrates, in one embodiment of the invention, the BLE transmission in advertising mode of the frames over time, by the BLE transmission module 11: transmission of an advertising frame on only 1 channel, channel rotation each time a frame is sent and addition of history data to limit data loss (in this case in question at least 6 previous data). The power required for BLE transmission of a dataset is 10-15 μJ/frame compared to 33 to 45 μJ/frame in a prior-art system.

Frame TR_1, TR_2, TR_3, . . . , TR_8 etc. is transmitted by the BLE transmission module 11 (broadcaster/advertiser) at transmission time t_1, t_2, t_3, . . . , t_8 etc., on channel 37, 38, 39, . . . on channel 38, etc., respectively.

The time between 2 successive transmissions of BLE data (i.e. the spacing between successive transmission times t_i and t_i+1), i.e. the advertising interval, may be set between 20 ms and 10.24 seconds (advertising interval, see BLE standard), an advertising interval 80 between 100 ms and 2 s conventionally being employed in most use cases. However, this transmission is not necessarily synchronized, i.e., in some embodiments, this interval changes over time, in particular if the device EM 10 is stand-alone in terms of power, and comprises an energy-harvesting system: the device EM 10 then prepares and sends a frame on a channel only when (and as soon as) the required power is available.

The size of the datasets and the depth of the history may be changed, in light of the size of the frame. For example, each of the datasets is 4 bytes in size and N=3, or each of the datasets is 1 byte in size and N=15, etc.

The BLE reception module 21 or observer/scanner, conventionally, scans in bursts at periodic intervals to see whether any data have been sent by a transmitter. At each interval, it scans 1 channel in turn of the P dedicated channels, and here successively each of the channels 37, 38 and 39.

The time between 2 scans (the scan interval 95) and the scan window T_{SW} may be set depending on the targeted application (between 20 ms and 10.24 s), the scan interval conventionally being 50 ms and the scan window T_{SW} 30 ms.

Thus, with reference to the top section of FIG. 10, which illustrates operation of the BLE receiver 21, a first scan 91 of channel 37 is triggered by the BLE reception module 21 during the scan window T_{SW} (depending on the embodiment, the receiver may implement the same channel loop as the transmitter, or variations may be made with respect to channel order: for example 37-38-39, 37-39-38; the second scan 92, of scan window T_{SW}, begins one scan interval after the beginning of the scan 91, and this time takes place on channel 38; and the third scan 93, of scan window T_{SW}, begins one scan interval after the beginning of the scan 92, and this time takes place on channel 39). The next scan again takes place on channel 37, etc.

Thus, the solution according to the invention has the following features:
the data are sent on a single advertising channel (here: channel 37, 38 or 39); this makes it possible to reduce by a factor of 3 the amount of energy required to send one frame (successively sent on 3 channels in the prior art); this technique alone is not recommended by those skilled in the art because immunity to radio interference is no longer guaranteed;
the channel is rotated each time a new frame is sent; this strategy improves immunity to radio interference, but reduces the number of frames received by the BLE receiver 21 (which itself rotates the channel in each scanning phase, asynchronously with the transmitter in advertising mode);
a history of the data is added to the frame, for example until the maximum amount of data allowed by the size of an advertising frame 50 is reached, to limit data loss (due to the non-synchronization of transmitter and receiver channel rotations in advertising mode).

The invention has the following advantages with respect to the prior art:
fully compatible with a conventional smartphone (i.e. prior-art) BLE scanner;
the power consumed per frame is limited: the solution theoretically divides the required power almost by 3 for P=3 compared to normal smartphone use, and by about 2.6 experimentally (in connection with the increase in frame length required to include a history);
one frame in three is received on statistical average if the receiver is constantly scanning; and limited to one frame in six on statistical average if the receiver implements scan windows and dead times of the same duration;
immunity to overloaded channels is preserved via channel rotation in transmission mode;
most of the data are recovered by virtue of the historical data integrated into the frame (for example at least 6 data, otherwise within the limit set by the size of the frame);
ideal solution for cumulative data (because in case of loss of information, interpolation is possible);
ideal solution in the case of a system EM 10 with energy harvesting operating in intermittent-computing mode (action triggered only when sufficient power is available):
increase in the number of transmissions and therefore in the granularity of the measurements (decreases in latency by a factor of 3);
decrease in the size of the capacitive storage element and therefore in system startup time.

The steps of the method in the BLE transmission module 11 and the steps of the method in the reception module 21, respectively, may be implemented by executing, on a processor, software instructions that are stored in a memory, the BLE transmission module 11 and the reception module 21 comprising such a memory and such a processor, respectively. Alternatively, they may be implemented by dedicated hardware, typically a digital integrated circuit, which is either specific (ASIC) or based on programmable logic (for example FPGA/Field Programmable Gate Array).

The BLE communication according to the invention therefore corresponds, in one embodiment considered by way of example, to
transmission on only 1 channel (rotation with each new transmission), i.e. [power 0 dBm, bit rate 1 Mbps, 46 bytes]: 15 μJ;
reception on 1 channel at a time, rotation being asynchronous with transmission (hence data loss and need for a history of the data);
which is therefore to be compared with conventional advertising in which each datum is transmitted successively on 3 channels:
power: 33-46 μJ per advertising frame (32 bytes including 16 bytes for the data) (in transmission mode),
SPW-2, 3 packets of 39 bytes (including 23 bytes for the data), power 0 dBm, unknown data rate (1 or 2 Mbps): 33 μJ (in transmission mode),
   (complete frame of 47 bytes including 31 bytes for the data).

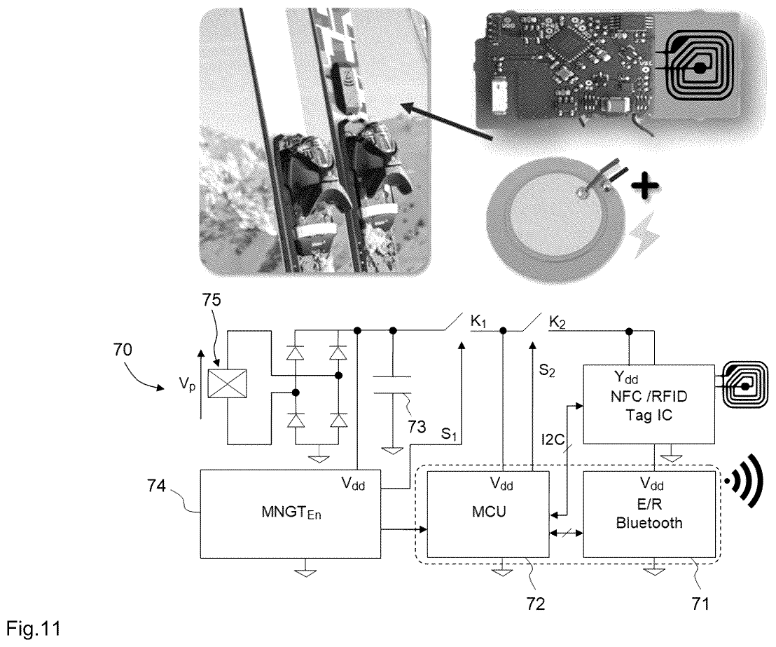

FIG. 11 schematically illustrates implementation of one embodiment of the invention on an IoT device 70 installed on a ski and allowing the duration and intensity of use of the ski (summed over time) to be monitored and the skier's level to be classified (evaluation of the degree of deformation of the ski). The data of the sensor on the ski are transmitted via Bluetooth Low Energy (BLE) (advertising mode) in real time from the IoT device to a receiver, a smartphone for example. The data thus transmitted is then time-stamped by the smartphone and may be matched with the data generated by sensors of the smartphone (GPS, gyrometer, accelerometer). This allows the level of the skier to be classified in each segment of her or his descent without the skier having to retrieve the data from the sensor via an NFC scan at the end of the descent. The BLE communication allows a maximum level of information to be obtained on the current descent, provided that the smartphone scans for and receives the BLE frames, because the data are not saved in the IoT device.

This IoT device 70 is stand-alone in terms of power and comprises a piezoelectric energy-harvesting system (conversion of the energy of deformation of the ski by a piezoelectric device), with piezoelectric elements 75 that generate the power required by the IoT device. The latter has very little power (asynchronously) to transmit data via BLE. As the power generated is low, it is essential to have a very low-power solution for transmitting data via BLE from the IoT device, in order to make wireless communication possible and maximize the frequency of data transmission.

The ultra-low power data transmission system comprises:
an nRF52810 system-on-chip (SoC) with a Bluetooth transceiver 71 and a microcontroller (MCU) 72;
an energy-storing capacitor 73: 10 μF;
an energy management circuit 74 (with voltage detectors) allowing Bluetooth transmission (47-byte frame) as soon as the storage capacity is full.

It is configured to transmit on 1 channel rotated as described above in accordance with the invention (this consuming 10-15 μJ/frame: i.e. equivalent of the energy stored in the capacitor).

It is configured to add to the frame, as shown in FIG. 4, in addition to the current time data 50_1, a history of the measurements made up of the 7 previously transmitted measurements, 50_21 to 50_27.

The addition of a history to the frame according to the invention makes it possible to collect all the missing data during a skiing descent (depicted path 200), as illustrated in FIG. 3, in which the circles indicate sent frames configured as in FIG. 4, only frames corresponding to circles without crosses inside actually being received; frames corresponding to circles with crosses inside are not received and the current time measurements (field 50_1) in these frames, which correspond to the circles with crosses inside, are reconstructed by virtue of the history present in the received frames.

In the example in question, where the datasets are transmission times, the receiver deduces, in light of all of the received successive datasets, the total duration of use of the ski.

1. A BLE telecommunication method, BLE standing for Bluetooth Low Energy, said method being implemented between a first telecommunication device and a second telecommunication device,
frames TR_i having previously been transmitted to the second telecommunication device (20) by the first telecommunication device at respective successive transmission times t_i, i=n−N to n−1, N, i and n being integers and N≥3;
P telecommunication channels having been allocated for BLE telecommunications between said first and second devices;
said method comprising the following steps implemented by the first telecommunication device with a view to transmitting, at transmission time t_n, a new dataset D_n to be transmitted:
obtaining the new dataset D_n to be transmitted;
constructing a frame, called frame TR_n, in light at least of the obtained dataset D_n;
selecting one telecommunication channel among said P allocated telecommunication channels;
transmitting, on the selected channel, the constructed frame T_n;
said method wherein the following steps are implemented by the first telecommunication device to transmit, at transmission time t_n, frame TR_n, each of the frames TR_i, i=n−N to n, conforming to a predefined frame format comprising a first data field intended to contain the current data and comprising N second data fields intended to contain data transmitted in the first field of previously transmitted frames;
during construction of frame TR_n:
inserting, into the first data field of frame TR_n, the dataset D_n;
inserting, into the jth second data field of frame TR_n, j=1 to N, the dataset D_(n−j) previously transmitted in the first field of frame TR_(n−j);
during selection of the communication channel:
a loop having been defined on the P channels ordered in a defined order, the channel selected for transmission of frame TR_n is the channel succeeding, in said defined loop, the channel that was selected for transmission of frame TR_(n−1) at transmission time t_(n−1); the channel previously selected for transmission of frame TR_n−j being the one succeeding, in said defined loop, the channel that was selected for transmission of frame TR_(n−j−1) at transmission time t_(n−j−1), j=1 to N;
said frame TR_n further being transmitted only on the single selected channel and in particular not being re-transmitted on any other of the P channels.

2. The BLE telecommunication method according to claim 1, wherein the spacing between two successive transmission times remains constant.

3. The BLE telecommunication method according to claim 1, wherein dataset D_i indicates the transmission time t_i, i=n−N to n, of frame TR_i.

4. The BLE telecommunication method according to claim 1, wherein, a scan window T_{SW} having been predefined and a scan interval T_{Si} having been defined, the second telecommunication device implements, every scan interval T_{Si}, a step of scanning, during the predefined scan window T_{SW}, one considered channel among the P channels, said P channels each being considered one after another, before starting again from the beginning.

5. A computer program, intended to be stored in the memory of a first telecommunication device and further comprising a microcomputer, said computer program comprising instructions that, when they are executed on the microcomputer, implement the steps of a method according to claim 1.

6. A telecommunication device, called the first telecommunication device below, configured to implement a BLE telecommunication with a second telecommunication device,
frames TR_i having previously been transmitted to the second telecommunication device (20) by the telecommunication device at respective successive transmission times t_i, i=n−N to n−1, N, i and n being integers and N≥3;
P telecommunication channels having been allocated for BLE telecommunications between said first and second devices;
the first telecommunication device being configured, with a view to transmitting, at transmission time t_n, a new dataset D_n to be transmitted, to obtain the new dataset D_n to be transmitted, to construct a frame, called frame TR_n, in light at least of the obtained dataset D_n, to select one telecommunication channel among said P allocated telecommunication channels, and to transmit, on the selected channel, the constructed frame T_n;
said first telecommunication device wherein the first telecommunication device, with a view to transmitting, at transmission time t_n, frame TR_n, each of the frames TR_i, i=n−N to n, conforming to a predefined frame format comprising a first data field intended to contain the current data and comprising N second data fields intended to contain data transmitted in the first field of previously transmitted frames, during construction of frame TR_n, inserts, into the first data field of frame TR_n, the dataset D_n, and inserts, into the jth second data field of frame TR_n, j=1 to N, the dataset D_(n−j) previously transmitted in the first field of frame TR_(n−j);
said first telecommunication device being configured to, a loop having been defined on the P channels ordered in a defined order, select as communication channel for transmission of frame TR_n, the channel succeeding, in said defined loop, the channel that was selected for transmission of frame TR_(n−1) at transmission time t_(n−1); the channel previously selected for transmission of frame TR_n−j being the one succeeding, in said defined loop, the channel that was selected for transmission of frame TR_(n−j−1) at transmission time t_(n−j−1), j=1 to N;
said frame TR_n further being transmitted only on the single selected channel and in particular not being re-transmitted on any other of the P channels.

7. The telecommunication device according to claim 6, configured to place a constant spacing between two successive transmission times.

8. The telecommunication device according to claim 6, configured to indicate, in dataset D_i, the transmission time t_i, i=n−N to n, of frame TR_i.

9. A BLE telecommunication system comprising a first telecommunication device according to claim 6, wherein, a scan window T_{SW} having been predefined and a scan interval T_{Si} having been defined, said system further comprises the second telecommunication device, which is configured to scan, every scan interval T_{Si}, during the predefined scan window T_{SW}, one considered channel among the P channels, said P channels each being considered one after another, before starting again from the beginning.
